(19) United States
(12) Patent Application Publication
(10) Pub. No.: US 2019/0346357 A1
(43) Pub. Date: Nov. 14, 2019

(54) PARTICLE COUNTER

(71) Applicant: NGK INSULATORS, LTD., Nagoya-City (JP)

(72) Inventors: Kazuyuki Mizuno, Nagoya-City (JP); Hidemasa Okumura, Nagoya-City (JP); Keiichi Kanno, Nagoya-City (JP)

(73) Assignee: NGK INSULATORS, LTD., Nagoya-City (JP)

(21) Appl. No.: 16/520,866

(22) Filed: Jul. 24, 2019

Related U.S. Application Data
(63) Continuation of application No. PCT/JP2018/001500, filed on Jan. 19, 2018.

(30) Foreign Application Priority Data
Jan. 26, 2017 (JP) 2017-012023

(51) Int. Cl. G01N 15/06; B03C 3/45; B03C 3/017

(52) U.S. Cl. CPC G01N 15/0656; G01N 15/0606; F01N 2560/05; B03C 3/017; B03C 3/45

(57) ABSTRACT

A particle counter includes a ceramic-made vent pipe, electric charge generating elements that generate electric charges by gaseous discharge, an electric field generating electrode, a collecting electrode, an electric field generating electrode and a removing electrode. Ground electrodes included in the electric charge generating elements are embedded in the vent pipe. Discharge electrodes included in the electric charge generating elements, the electric field generating electrodes for collection and removal, the collecting electrode, and the removing electrode are disposed along the inner wall surface of the vent pipe. The electric charge generating elements are disposed along the inner wall surface of the vent pipe.

### BACKGROUND OF THE INVENTION

### 1. Field of the Invention

The present invention relates to a particle counter.

### 2. Description of the Related Art

In one known particle counter, ions are generated by corona discharge using an electric charge generating element, and fine particles in a measurement gas are charged by the ions. The charged fine particles are collected by a collecting electrode, and the number of fine particles is measured on the basis of the amount of electric charges on the collected fine particles (see, for example, PTL 1). Another proposed particle counter includes a removing electrode for removing excess electric charges not added to the fine particles.

### CITATION LIST

### Patent Literature

PTL 1: WO 2015/146456 A1

### SUMMARY OF THE INVENTION

In PTL 1, the removing electrode for collecting electric charges not added to the fine particles and the collecting electrode for collecting the charged fine particles are formed along an inner wall surface of a vent pipe. However, it is necessary that a needle-shaped electrode included in the electric charge generating element be installed in a housing later. Moreover, the needle-shaped electrode can obstruct the flow of the measurement gas. Another problem is that the fine particles tend to adhere to the needle-shaped electrode.

The present invention has been made to solve the foregoing problems, and it is a principal object to provide a particle counter which includes a vent pipe and electrodes that can be easily produced integrally, in which an electric charge generating element does not obstruct the flow of gas, and in which fine particles do not tend to adhere to the electric charge generating element.

The particle counter of the present invention includes:

a ceramic-made vent pipe;

an electric charge generating element that includes a pair of electrodes for generating electric charges by gaseous discharge and adds the electric charges to fine particles in gas introduced into the vent pipe to thereby form charged fine particles;

a collecting electrode that is disposed downstream of the electric charge generating element in a flow of the gas within the vent pipe and collects the charged fine particles;

a collection electric field generating electrode that generates an electric field on the collecting electrode;

a removing electrode that is disposed between the electric charge generating element and the collecting electrode within the vent pipe and removes excess electric charges not added to the fine particles;

a removal electric field generating electrode that generates an electric field on the removing electrode; and

a number detecting unit that detects the number of charged fine particles on the basis of a physical quantity that varies according to the number of charged fine particles collected on the collecting electrode,

wherein one of the pair of electrodes included in the electric charge generating element, the collecting electrode, and the removing electrode are disposed along an inner wall surface of the vent pipe, and

wherein the other one of the pair of electrodes included in the electric charge generating element, the collection electric field generating electrode, and the removal electric field generating electrode are disposed along the inner wall surface of the vent pipe or embedded in the vent pipe.

In this particle counter, the electric charge generating element generates electric charges by gaseous discharge, and the generated electric charges are added to the fine particles introduced into the vent pipe to thereby form charged fine particles. The charged fine particles are collected by the collecting electrode disposed downstream of the electric charge generating element in the gas flow. Excess electric charges not added to the fine particles are removed by the removing electrode disposed between the electric charge generating element and the collecting electrode. The number of fine particles in the gas is detected on the basis of the physical quantity that varies according to the number of charged fine particles collected on the collecting electrode. One of the pair of electrodes included in the electric charge generating element, the collecting electrode, and the removing electrode are formed along the inner wall surface of the vent pipe. The other one of the pair of electrodes included in the electric charge generating element, the collection electric field generating electrode, and the removal electric field generating electrode are formed along the inner wall surface of the vent pipe or embedded in the vent pipe. Therefore, the vent pipe and the electrodes can be easily produced integrally. With the electric charge generating element, in contrast with the use of the needle-shaped electrode, the gas flow is not obstructed, and the fine particles are unlikely to adhere to the electric charge generating element.

In the present description, the phrase “electric charges” is intended to encompass not only positive charges and negative charges but also ions. The phrase “to detect the number of fine particles” is intended to mean not only to measure the number of fine particles but also to judge whether or not the number of fine particles falls within a prescribed numerical range (e.g., whether or not the number of fine particles exceeds a prescribed threshold value). The “physical quantity” may be any parameter that varies according to the number of charged fine particles (the amount of electric charges) and is, for example, an electric current.

In the particle counter of the present invention, the electrodes disposed along the inner wall surface of the vent pipe may be joined to the inner wall surface of the vent pipe using an inorganic material or may be joined to the inner wall surface of the vent pipe by sintering. In any case, the heat resistance is higher than that when the electrodes are joined using an organic material.

The particle counter of the present invention may further include a plurality of the collecting electrodes that are disposed at intervals from an upstream side toward a downstream side in the flow of the gas. In this case, in terms of fluid dynamics, smaller charged fine particles are collected by collecting electrodes on the upstream side, and larger charged fine particles are collected by collecting electrodes on the downstream side. Therefore, the charged fine particles can be easily classified.

In the particle counter of the present invention, the number detecting unit may detect the number of charged fine particles on the basis of the capacitance of a pseudo capacitor composed of the collection electric field generating electrode, the collecting electrode, and an internal space of the vent pipe. The number of charged fine particles may be detected on the basis of a minute current flowing through the collecting electrode. However, when the minute current is amplified, noise is also amplified, so that it may be difficult to increase accuracy. However, the capacitance can be easily measured using, for example, an LCR meter with relatively high accuracy, so that the number of charged fine particles can be detected with high accuracy.

The particle counter of the present invention may further include a piezoelectric vibrator including a front electrode, a rear electrode, and a piezoelectric element sandwiched therebetween, and the front electrode of the piezoelectric vibrator may serve as the collecting electrode. The number detecting unit may detect the number of charged fine particles on the basis of a resonance frequency that varies according to the number of charged fine particles collected on the front electrode with the piezoelectric vibrator vibrating. Since the resonance frequency varies according to the mass of the charged fine particles collected on the collecting electrode, the resonance frequency can be measured using, for example, an impedance analyzer with relatively high accuracy. Therefore, the number of charged fine particles can be detected with high accuracy.

In the particle counter of the present invention, the vent pipe may be a cylindrical vent pipe prepared by joining two half members made of ceramic and each having a semicircular cross section. In this case, as compared with the case in which the vent pipe has a rectangular cross section, the flow of the gas is less likely to be disturbed. Generally, an exhaust pipe has a circular cross section, and therefore the particle counter can be easily connected to the exhaust pipe. Moreover, since the two half members are joined together, the vent pipe having a circular cross section can be easily produced.

No particular limitation is imposed on the application of the particle counter of the present invention. The particle counter is applicable to, for example, an ambient air quality survey, an indoor environment survey, a pollution survey, measurement of combustion particles from vehicles etc., monitoring of a particle generation environment, monitoring of a particle synthesis environment, etc. In particular, when exhaust gas from a vehicle is measured, the particle counter of the present invention is required to have long-term heat resistance and long-term durability against high-temperature exhaust gas. When fine particles adhering to a discharge electrode, a ground electrode, the collecting electrode, and the removing electrode are heated and burnt, higher heat resistance is required.

### BRIEF DESCRIPTION OF THE DRAWINGS

FIG. 1 is a cross-sectional view showing a schematic structure of a particle counter 10.

FIG. 2 is a cross-sectional view taken along A-A in FIG. 1.

FIG. 3 is a perspective view showing a schematic structure of an electric charge generating element 20.

FIGS. 4A to 4F are process charts for production of a sintered alumina plate 123 including electrodes 22, 24, 44, and 54.

FIG. 5 is a cross-sectional view of the sintered alumina plate 123 including the electrodes 22, 24, 42, and 52.

FIGS. 6A to 6C are process charts for production of a sintered alumina wall 125.

FIGS. 7A and 7B are process charts for production of a vent pipe 12.

FIGS. 8A to 8E are other process charts for production of the vent pipe 12.

FIG. 9 is a cross-sectional view of a modification of the electric charge generating elements 20.

FIG. 10 is a cross-sectional view of a particle counter 110.

FIG. 11 is a cross-sectional view of a particle counter 210.

FIG. 12 is a perspective view of a cylindrical vent pipe 112.

FIG. 13 is a perspective view of half members 112a and 112b.

FIG. 14 is a cross-sectional view of a particle counter 310.

FIG. 15 is a cross-sectional view of a particle counter 410.

FIG. 16 is a cross-sectional view of a particle counter 510.

FIG. 17 is a cross-sectional view of a particle counter 610.

### DETAILED DESCRIPTION OF THE INVENTION

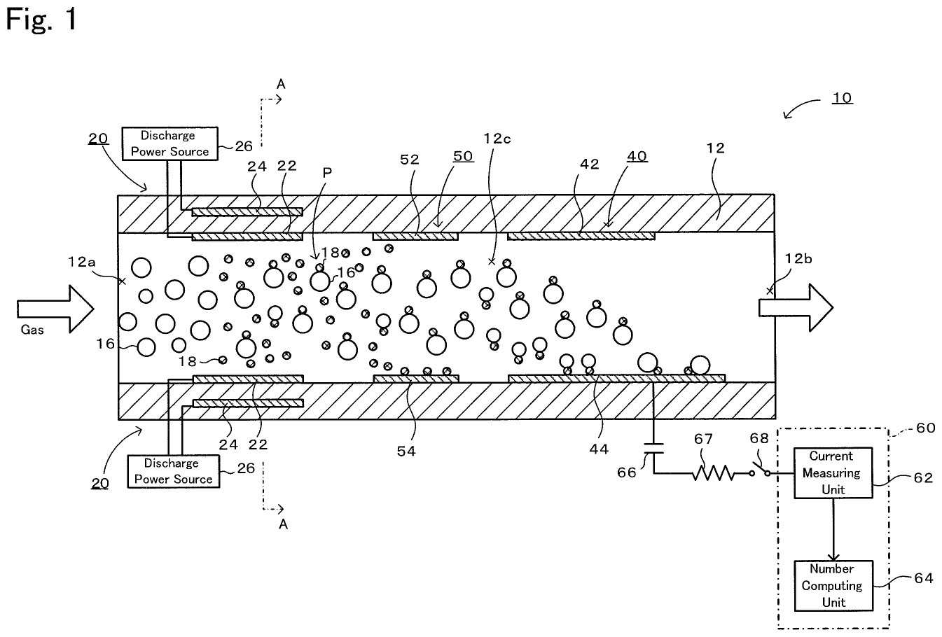

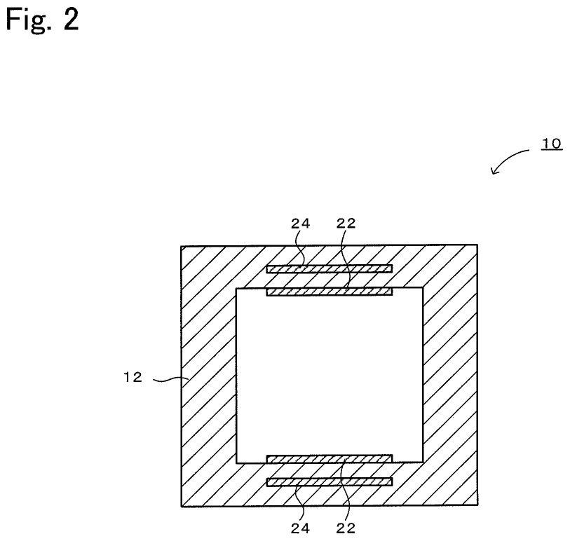

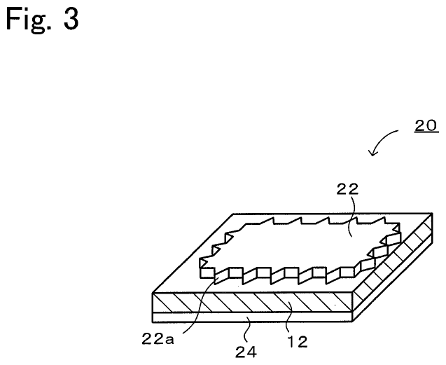

Preferred embodiments of the present invention will be described with reference to the drawings. FIG. 1 is a cross-sectional view showing a schematic structure of a particle counter 10, and FIG. 2 is a cross-sectional view taken along A-A in FIG. 1. FIG. 3 is a perspective view showing a schematic structure of an electric charge generating element 20.

The particle counter 10 detects the number of fine particles contained in gas (for example, exhaust gas from an automobile). The particle counter 10 includes electric charge generating elements 20, a collecting unit 40, and an excess charge removing unit 50 that are disposed in a vent pipe 12. The particle counter 10 further includes a number counter unit 60 electrically connected to the collecting unit 40.

The vent pipe 12 is a ceramic-made pipe having a rectangular cross section. The vent pipe 12 includes a gas inlet 12a for introducing the gas into the vent pipe 12, a gas outlet 12b for discharging the gas passing through the vent pipe 12, and a hollow portion 12c that is a space between the gas inlet 12a and the gas outlet 12b. No particular limitation is imposed on the type of ceramic, and examples of the ceramic include alumina, aluminum nitride, silicon carbide, mullite, zirconia, titania, silicon nitride, magnesia, glass, and mixtures thereof.

The electric charge generating elements 20 are disposed on upper and lower surfaces of the vent pipe 12 on the side close to the gas inlet 12a. Each of the electric charge generating elements 20 includes a discharge electrode 22 and a ground electrode 24. The discharge electrode 22 is disposed along the inner wall surface of the vent pipe 12 and has a plurality of small protrusions 22a around a rectangular shape as shown in FIG. 3. The ground electrode 24 is a rectangular electrode and is embedded in an inner wall of the vent pipe 12 so as to face the discharge electrode 22. In each of the electric charge generating elements 20, when a voltage from a discharge power source 26 is applied between the discharge electrode 22 and the ground electrode 24, gaseous discharge is generated due to the potential difference between these electrodes. In this case, a portion of the vent pipe 12 that is sandwiched between the discharge electrode 22 and the ground electrode 24 serves as a dielectric layer. When the gas passes through the gaseous discharge, electric charges 18 are added to fine particles 16 in the gas, and charged fine particles P are thereby formed. The discharge electrode 22 corresponds to one of the pair of electrodes in the electric charge generating element 20, and the ground electrode 24 corresponds to the other one.

The material used for the discharge electrode 22 is preferably a metal having a melting point of 1,500° C. or higher, from the viewpoint of heat resistance during discharge. Examples of such a metal include titanium, chromium, iron, cobalt, nickel, niobium, molybdenum, tantalum, tungsten, iridium, palladium, platinum, gold, and alloys thereof. Of these, platinum and gold having a small ionization tendency are preferred from the viewpoint of corrosion resistance.

The collecting unit 40 is a unit for collecting the charged fine particles P. The collecting unit 40 includes an electric field generating electrode 42 (a collection electric field generating electrode) and a collecting electrode 44 that face each other. These electrodes 42 and 44 are disposed along the inner wall surface of the vent pipe 12. When a voltage from an unillustrated electric field generating power source is applied between the electric field generating electrode 42 and the collecting electrode 44, an electric field is generated between an electric field generating electrode 42 and a collecting electrode 44 (on the collecting electrode 44). The charged fine particles P entering the hollow portion 12c are attracted toward the collecting electrode 44 by the electric field and collected on the collecting electrode 44. The electric field generating electrode 42 corresponds to the collection electric field generating electrode.

The excess charge removing unit 50 is a unit for removing electric charges 18 not added to the fine particles 16 and is disposed forward of the collecting unit 40 (upstream in the moving direction of the gas). The excess charge removing unit 50 includes the electric field generating electrode (removal electric field generating electrode) 52 and the removing electrode 54 that face each other. These electrodes 52 and 54 are disposed along the inner wall surface of the vent pipe 12. A voltage smaller by at least one order of magnitude than the voltage applied between the electric field generating electrode 42 and the collecting electrode 44 is applied between the electric field generating electrode 52 and the removing electrode 54. A weak electric field is thereby generated between the electric field generating electrode 52 and the removing electrode 54 (on the removing electrode 54). The electric charges 18 are generated by the electric charge generating elements 20 through gaseous discharge, and electric charges 18 not added to the fine particles 16 are attracted toward the removing electrode 54 by the weak electric field and discarded to the GND.

The number counter unit 60 is a unit for measuring the number of fine particles 16 on the basis of the amount of the electric charges 18 on the charged fine particles P collected by the collecting electrode 44 and includes a current measuring unit 62 and a number computing unit 64. A capacitor 66, a resistor 67, and a switch 68 are connected in series from the collecting electrode 44 side between the current measuring unit 62 and the collecting electrode 44. The switch 68 is preferably a semiconductor switch. When the switch 68 is turned on and the collecting electrode 44 is electrically connected to the current measuring unit 62, a current based on the electric charges 18 added to the charged fine particles P adhering to the collecting electrode 44 is transmitted as a transient response to the current measuring unit 62 through the series circuit including the capacitor 66 and the resistor 67. An ordinary ammeter can be used as the current measuring unit 62. The number computing unit 64 computes the number of fine particles 16 on the basis of the current value from the current measuring unit 62.

Next, an example of the use of the particle counter 10 will be described. When fine particles contained in exhaust gas from an automobile are measured, the particle counter 10 is attached inside an exhaust pipe of the engine. In this case, the particle counter 10 is attached such that the exhaust gas is introduced from the gas inlet 12a of the particle counter 10 into the vent pipe 12 and then discharged from the gas outlet 12b.

When the fine particles 16 contained in the exhaust gas introduced into the vent pipe 12 from the gas inlet 12a pass through the electric charge generating elements 20, electric charges 18 are added to the fine particles 16, and charged fine particles P are thereby formed. In the excess charge removing unit 50, the electric field is weak, and the length of the removing electrode 54 is shorter than, i.e., 1/20 to 1/10 of, the length of the hollow portion 12c. The charged fine particles P pass through the excess charge removing unit 50 without any change in their state and reach the collecting unit 40. Electric charges 18 not added to the fine particles 16 are attracted toward the removing electrode 54 of the excess charge removing unit 50 even though the electric field is weak and are then discarded to the GND. Therefore, almost no unnecessary electric charges 18 not added to the fine particles 16 reach the collecting unit 40.

When the charged fine particles P reach the collecting unit 40, the charged fine particles P are attracted to and collected on the collecting electrode 44. Then a current based on the electric charges 18 on the charged fine particles P adhering to the collecting electrode 44 is transmitted as a transient response to the current measuring unit 62 of the number counter unit 60 through the series circuit composed of the capacitor 66 and the resistor 67.

The relation between the current I and the amount q of electric charges is I=dq/(dt), q=∫I dt. Therefore, the number computing unit 64 integrates (accumulates) the current value from the current measuring unit 62 over a period of time during which the switch 68 is ON (a switch ON period) to determine the integrated value of the current value (the cumulative amount of electric charges). After the switch ON period, the cumulative amount of electric charges is divided by the elementary charge to determine the total number of electric charges (the number of collected electric charges). Then the number of collected electric charges is divided by the average number of electric charges added to one fine particle 16, and the number of fine particles 16 adhering to the collecting electrode 44 over a given time (for example, 5 to 15 seconds) can thereby be determined. Then the number computing unit 64 repeats the mathematical operation for computing the number of fine particles 16 within the given time over a given period of time (e.g., 1 to 5 minutes) and sums the results, and the number of fine particles 16 that adhere to the collecting electrode 44 in the given period of time can thereby be computed. By using the transient response of the capacitor 66 and the resistor 67, a small current can be measured, and the number of fine particles 16 can be detected with high accuracy. By using, for example, a resistor 67 with a large resistance value to increase the time constant, a very small current of the order of pA (picoamperes) or nA (nonoamperes) can be measured.

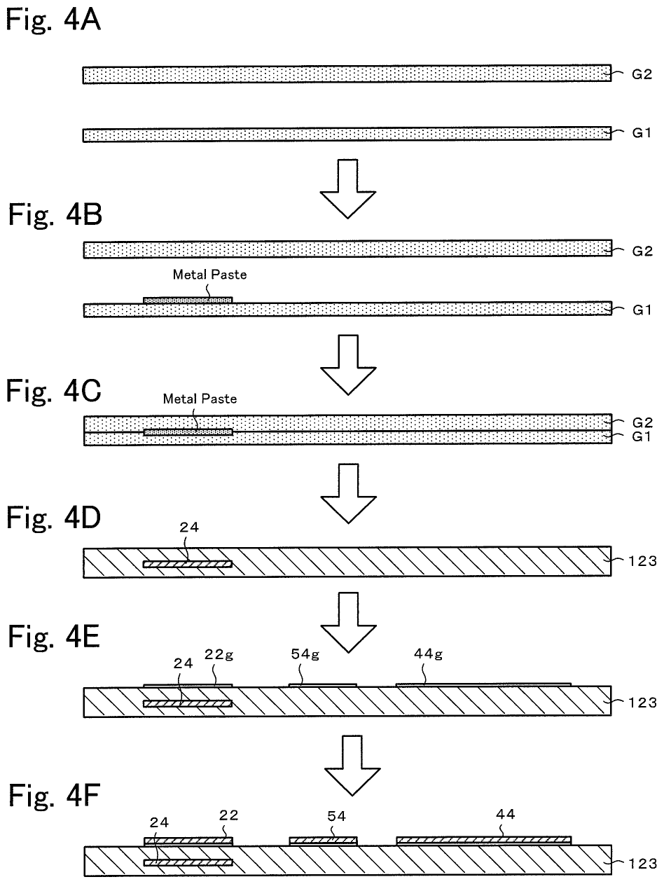

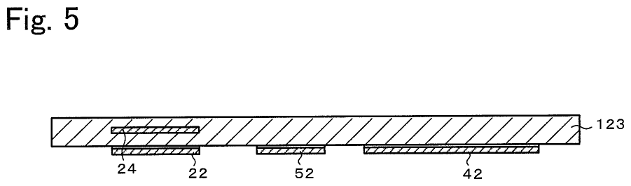

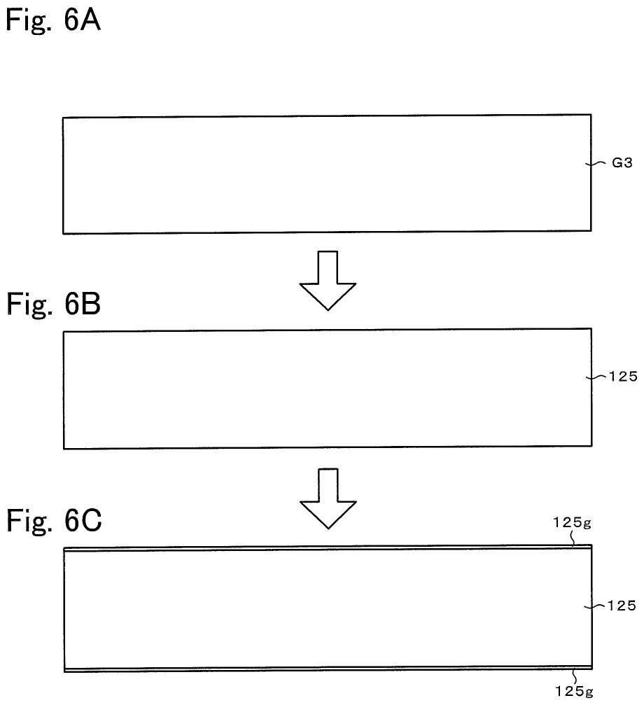

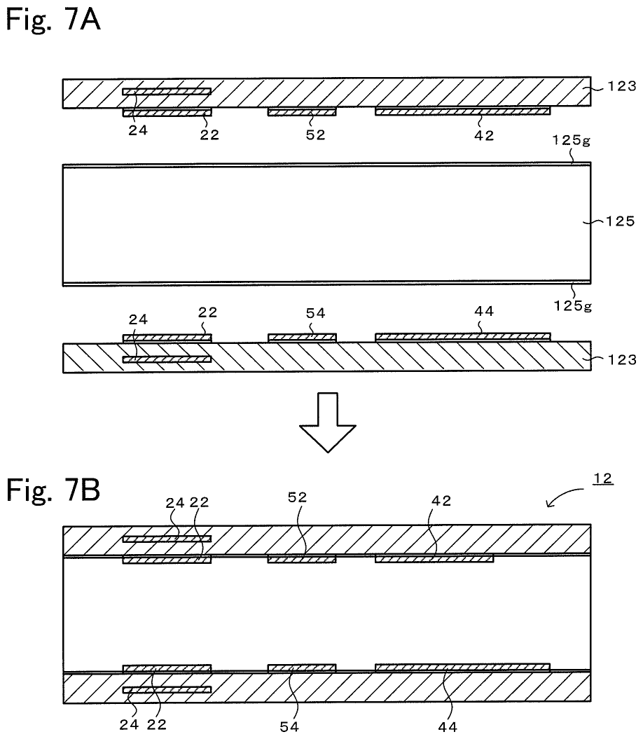

Next, a production example of the particle counter 10, particularly, a production example of the vent pipe 12 will be described. FIGS. 4A to 4F are a process charts for production of a sintered alumina plate 123 including electrodes 22, 24, 44, and 54, and FIG. 5 is a cross-sectional view of a sintered alumina plate 123 including the electrodes 22, 24, 42, and 52. FIGS. 6A to 6C are process charts for production of a sintered alumina wall 125, and FIGS. 7A and 7B are process charts for production of the vent pipe 12. First, a polyvinyl butyral resin (PVB) serving as a binder, bis(2-ethylhexyl)phthalate (DOP) serving as a plasticizer, xylene serving as a solvent, and 1-butanol serving as a solvent are added to alumina powder, and these materials are mixed in a ball mill for 30 hours to prepare a green sheet-forming slurry. The slurry is subjected to vacuum defoaming treatment to adjust its viscosity to 4,000 cps. Then a sheet material is produced from the resulting slurry using a doctor blade apparatus. The sheet material is cut to produce green sheets G1 and G2 that later become members forming the upper and bottom surfaces of the vent pipe 12 (see FIG. 4A).

Next, a metal paste (e.g., a Pt paste) that later becomes a ground electrode 24 is screen-printed on a surface of the green sheet G1 to a fired thickness of 5 μm and dried at 120° C. for 10 minutes (see FIG. 4B). Next, the green sheet G1 and the green sheet G2 are stacked to form a stack such that the metal paste formed on the surface of the green sheet G1 is contained within the stack (see FIG. 4C). The stack is fired and integrated at 1,450° C. for 2 hours. The metal paste thereby becomes the ground electrode 24, and the green sheet G1 and the green sheet G2 are fired to form one sintered alumina plate 123 (see FIG. 4D).

Next, glass pastes 22g, 54g, and 44g each used as a bonding material are screen-printed on a surface of the sintered alumina plate 123 at positions at which the discharge electrode 22, the removing electrode 54, and the collecting electrode 44 are to be disposed and are then dried at room temperature for 8 hours (see FIG. 4E). A SUS 316-made sheet material having a thickness of 20 μm is cut by laser processing to the sizes of the discharge electrode 22, the removing electrode 54, and the collecting electrode 44, and fading caused by heat and burrs are removed by chemical polishing. The thus-obtained discharge electrode 22, removing electrode 54, and collecting electrode 44 are bonded to the glass pastes 22g, 54g, and 44g, respectively, formed on the surface of the sintered alumina plate 123 and heated to 450° C. for 1 hour to join them together (see FIG. 4F). The sintered alumina plate 123 with the electrodes 22, 54, and 44 formed along its surface and the ground electrode 24 embedded therein is thereby obtained. Similarly, as shown in FIG. 5, a sintered alumina plate 123 with electrodes 22, 52, and 42 formed along its surface and a ground electrode 24 embedded therein is also produced.

A green sheet G3 that later becomes a member forming a wall of the vent pipe 12 is produced using the doctor blade apparatus in the same manner as that for the green sheets G1 and G2 (see FIG. 6A). The green sheet G3 is fired at 1,450° C. for 2 hours to obtain a sintered alumina wall 125 (see FIG. 6B). A glass paste 125g is screen-printed onto the upper and lower end surfaces of the sintered alumina wall 125 and dried at room temperature for 8 hours. The sintered alumina wall 125 with the glass paste 125g printed on the upper and lower end surfaces is thereby obtained (see FIG. 6C). The glass paste 125g used is bondable at a temperature (e.g., 150° C.) lower than the bondable temperature of the glass pastes 22g, 54g, and 44g used to bond the discharge electrode 22, the removing electrode 54, and the collecting electrode 44, respectively, to the sintered alumina plate 123. Two sintered alumina walls 125 shown in FIG. 6C are produced.

Next, the two sintered alumina walls 125 are disposed upright on the surface of the sintered alumina plate 123 on which the electrodes 22, 54, and 44 are disposed, and the sintered alumina plate 123 is attached so as to extend between the two sintered alumina walls 125. The sintered alumina plate 123 is disposed such that the surface with the electrodes 22, 52, and 42 formed thereon faces downward (see FIG. 7A). In this state, the glass paste 125g is interposed between the sintered alumina plates 123 and the sintered alumina walls 125. The assembly is heated to 150° C. for two hours to join the sintered alumina plates 123 and the sintered alumina walls 125 together through the glass. A vent pipe 12 is thereby obtained, in which the ground electrodes 24 are embedded in the inner walls of the vent pipe 12 and in which the discharge electrodes 22, the electric field generating electrodes 42 and 52, the collecting electrode 44, and the removing electrode 54 are formed along the inner wall surface (see FIG. 7B).

In the particle counter 10 described above in detail, the discharge electrodes 22, the electric field generating electrodes 42 and 52, the collecting electrode 44, and the removing electrode 54 are formed along the inner wall surface of the vent pipe 12, and the ground electrodes 24 are embedded below the inner wall surface of the vent pipe 12. Therefore, the vent pipe 12 and the electrodes 22, 24, 42, 44, 52, and 54 can be easily produced integrally. The discharge electrodes 22 each have a shape extending along the inner wall surface of the vent pipe 12. Therefore, unlike the conventionally used needle-shaped electrode, the discharge electrodes 22 do not obstruct the gas flow, and the fine particles are unlikely to adhere to the discharge electrodes 22.

The electrodes 22, 42, 44, 52, and 54 are joined to the inner wall surface of the vent pipe 12 through an inorganic material, i.e., the glass. Therefore, the heat resistance of the joints is higher than that of joints formed by joining the electrodes 22, 42, 44, 52, and 54 using an organic material.

The present invention is not limited to the first embodiment described above, and it will be appreciated that the present invention can be implemented in various forms so long as they fall within the technical scope of the invention.

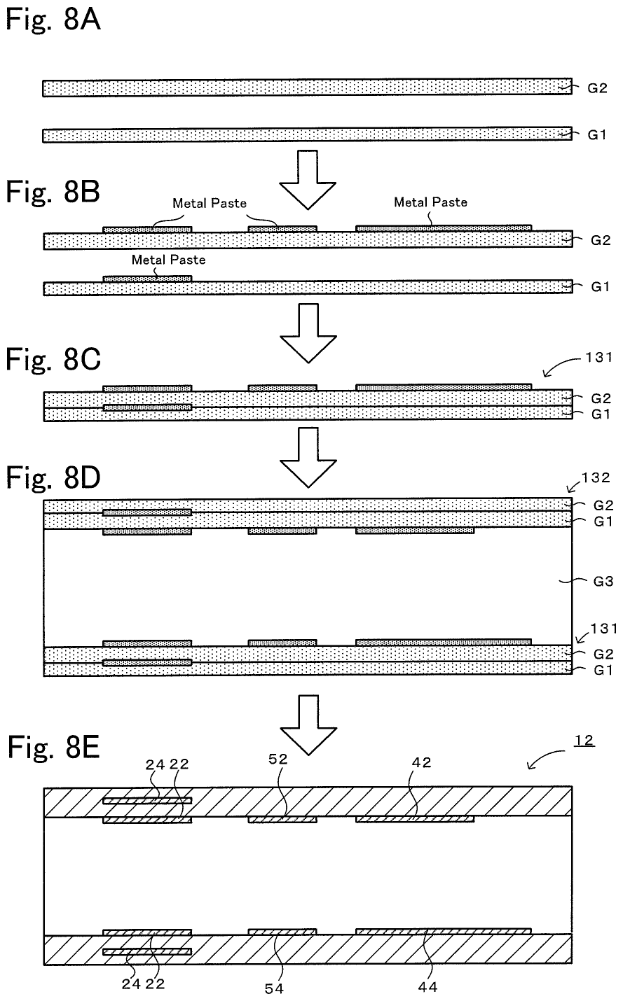

For example, in the embodiment described above, the vent pipe 12 is produced according to the production process charts in FIGS. 4A to 7B. However, the vent pipe 12 may be produced according to production process charts in FIGS. 8A to 8E. Specifically, first, green sheets G1 and G2 are produced in the same manner as in the embodiment described above (see FIG. 8A). Then a metal paste that later becomes a ground electrode 24 is screen-printed on a surface of the green sheet G1 to a fired thickness of 5 μm and dried at 120° C. for 10 minutes. A metal paste that later becomes a discharge electrode 22, the removing electrode 54, and the collecting electrode 44 is screen-printed on a surface of the green sheet G2 to a fired thickness of 5 μm and then dried at 120° C. for 10 minutes (see FIG. 8B). Next, the green sheet G1 and the green sheet G2 are stacked to form a first stack 131 such that the metal paste formed on the surface of the green sheet G1 is contained within the stack and that the metal paste formed on the surface of the green sheet G2 is located on an outer surface (see FIG. 8C). Then a second stack 132 is produced in a similar manner. In the second stack 132, a metal paste that later becomes the electric field generating electrodes 42 and 52 is screen-printed instead of the metal paste that later becomes the collecting electrode 44 and the removing electrode 54. Then two green sheets G3 are produced in the same manner as in the embodiment described above. The first stack 131 is placed such that the surface with the metal paste printed thereon facing up, and the green sheets G3 serving as supports are disposed upright on opposite sides of the first stack 131. Then the second stack 132 is attached so as to extend between the green sheets G3. The second stack 132 is disposed such that the surface with the metal paste printed thereon faces down (see FIG. 8D). The assembly is fired at 1,450° C. for 2 hours. In this manner, a vent pipe 12 is obtained, in which the ground electrodes 24 are embedded in inner walls of the vent pipe 12 and in which the discharge electrodes 22, the electric field generating electrodes 42 and 52, the collecting electrode 44, and the removing electrode 54 are formed along the inner wall surface (see FIG. 8E). In this case also, the vent pipe 12 and the electrodes 22, 24, 42, 44, 52, and 54 can be easily produced integrally. The discharge electrodes 22 each have a shape extending along the inner wall surface of the vent pipe 12. Therefore, unlike the conventionally used needle-shaped electrode, the discharge electrodes 22 do not obstruct the gas flow, and the fine particles are unlikely to adhere to the discharge electrodes 22. The electrodes 22, 42, 44, 52, and 54 are joined to the vent pipe 12 by sintering. Therefore, the heat resistance of the joints is higher than that of joints formed by joining the electrodes to the inner wall surface of the vent pipe 12 using an organic material.

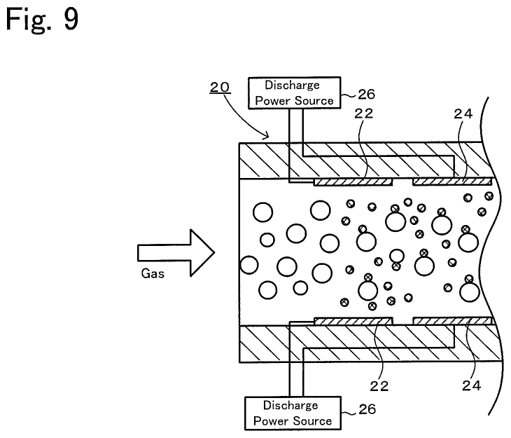

In the embodiment described above, the ground electrodes 24 are embedded in the inner walls of the vent pipe 12. However, as shown in FIG. 9, the ground electrodes 24 may be disposed along the inner wall surface of the vent pipe 12 so as to be separated from the discharge electrodes 22. In this case, the ground electrodes 24 may be joined to the inner wall surface of the vent pipe 12 through the glass paste, as are the discharge electrodes 22 etc. Alternatively, the ground electrodes 24 may each be formed as a sintered metal produced by firing a metal paste screen-printed on the inner wall surface of the vent pipe 12.

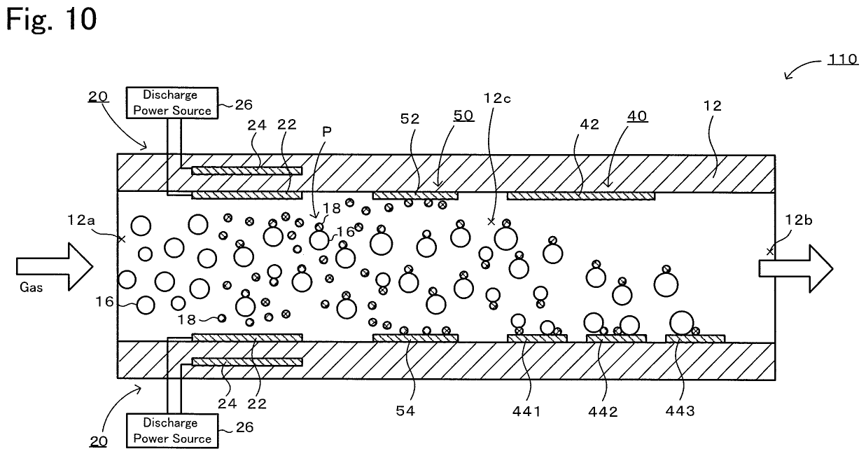

In the embodiment described above, the collecting electrode 44 is provided as a single electrode. However, a plurality of collecting electrodes may be disposed at intervals from the upstream side in the gas flow toward the downstream side. An example of this structure is shown in FIG. 10. A particle counter 110 in FIG. 10 includes three collecting electrodes 441, 442, and 443. In FIG. 10, the same components as those in the embodiment described above are denoted by the same numerals. In this structure, in terms of fluid dynamics, smaller charged fine particles P are collected by the collecting electrode 441 on the upstream side, and larger charged fine particles P are collected by the collecting electrode 443 on the downstream side. Therefore, the charged fine particles P can be classified. In this case, the number counter unit 60 is provided for each of the collecting electrodes 441, 442, and 443. The number of small-sized charged fine particles P, the number of medium-sized charged fine particles P, and the number of large-sized charged fine particles P can thereby be measured separately.

In the embodiment described above, the number of charged fine particles P is computed on the basis of the minute current flowing through the collecting electrode 44. However, when the minute current is amplified, noise is also amplified, so that it may be difficult to compute the number of charged fine particles with high accuracy. Therefore, capacitance may be measured instead of the minute current. Specifically, the capacitance of a pseudo capacitor composed of the electric field generating electrode 42, the collecting electrode 44, and the internal space of the vent pipe 12 sandwiched therebetween is measured, and the number of charged fine particles is computed on the basis of the measured capacitance. An example of this method will be described below. The capacitance when no charged fine particles P are collected on the collecting electrode 44 and an increase in the capacitance when one charged fine particle P is collected on the collecting electrode 44 are measured in advance using an LCR meter at a specific frequency (for example, 1 kHz). Then the capacitance at this frequency when the measurement gas is introduced into the vent pipe 12 is measured by the LCR meter. The increase in capacitance before and after the measurement is divided by the increase in capacitance when one charged fine particle P is collected to thereby compute the number of charged fine particles P collected on the collecting electrode 44 during the measurement. Since the capacitance can be easily measured by, for example, an LCR meter with relatively high accuracy, the number of charged fine particles P can be computed with high accuracy.

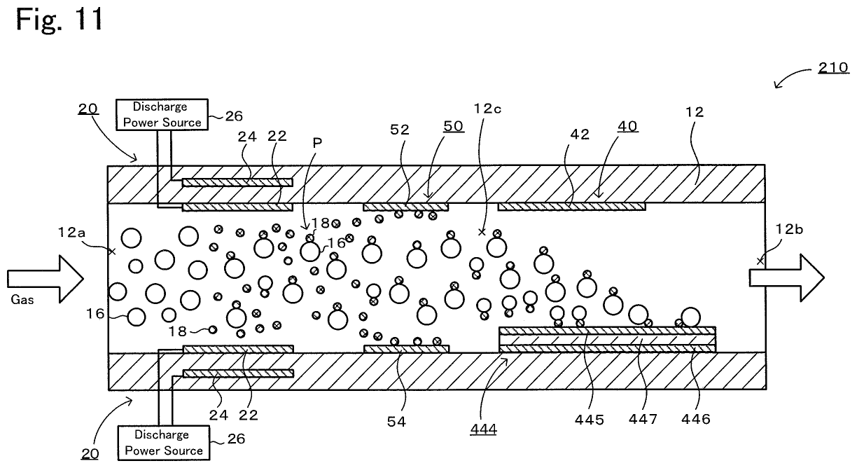

Instead of measuring the minute current, a resonance frequency may be measured. Specifically, as shown in a particle counter 210 in FIG. 11, instead of the collecting electrode 44, a piezoelectric vibrator 444 including a piezoelectric element 447 sandwiched between a front electrode 445 and a rear electrode 446 is disposed on the inner wall surface of the vent pipe 12. In FIG. 11, the same components as those in the embodiment described above are denoted by the same numerals. In this structure, the front electrode 445 is used as the collecting electrode. In this case, a weak sine wave is applied to the piezoelectric vibrator 444. The resonance frequency before charged fine particles P adhere to the front electrode 445 and the change in resonance frequency when one charged fine particle P is collected on the front electrode 445 are measured in advance. Then the resonance frequency when the measurement gas is introduced into the vent pipe 12 is measured. The change in resonance frequency before and after the measurement is divided by the change in the resonance frequency when one charged fine particle is collected to thereby compute the number of charged fine particles P collected on the front electrode 445 during the measurement. Since the resonance frequency varies according to the mass of the charged fine particles P collected on the front electrode 445, the resonance frequency can be measured using, for example, an impedance analyzer with relatively high accuracy. Therefore, the number of charged fine particles P can be computed with high accuracy.

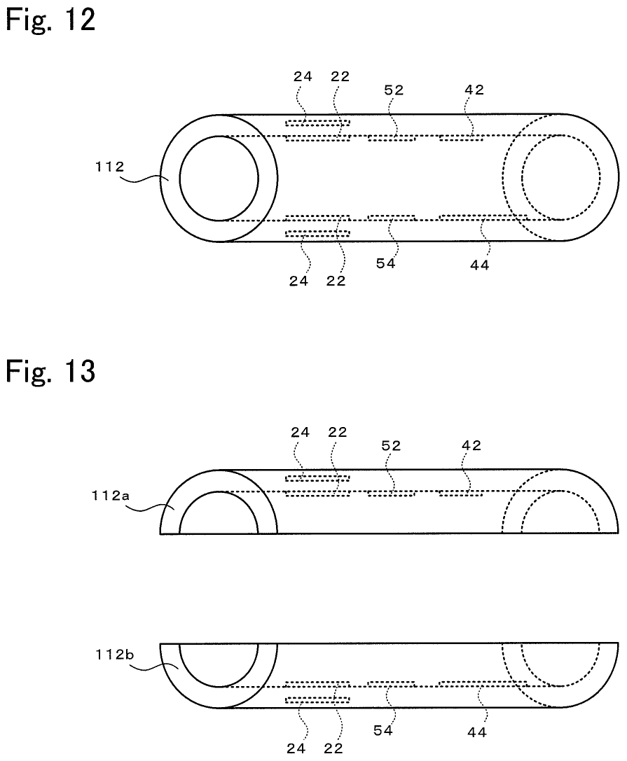

In the embodiment described above, the vent pipe 12 has a rectangular cross section. However, as shown in FIG. 12, a vent pipe 112 having a cylindrical shape, i.e., having a circular cross section may be used. In FIG. 12, the same components as those in the embodiment described above are denoted by the same numerals. In this case, in contrast to the case where the cross section is rectangular, the flow of the gas is unlikely to be disturbed. Generally, an exhaust pipe (for example, an exhaust pipe of an automobile) has a circular cross section, and therefore the vent pipe 112 can be easily connected to the exhaust pipe. To produce the vent pipe 112 having a circular cross section, ceramic-made half members 112a and 112b having a semicircular cross section may be joined using glass to form a cylindrical shape, as shown in FIG. 13. Electrodes are provided in the half members 112a and 112b in advance. This allows the vent pipe 112 having the circular cross section to be produced easily.

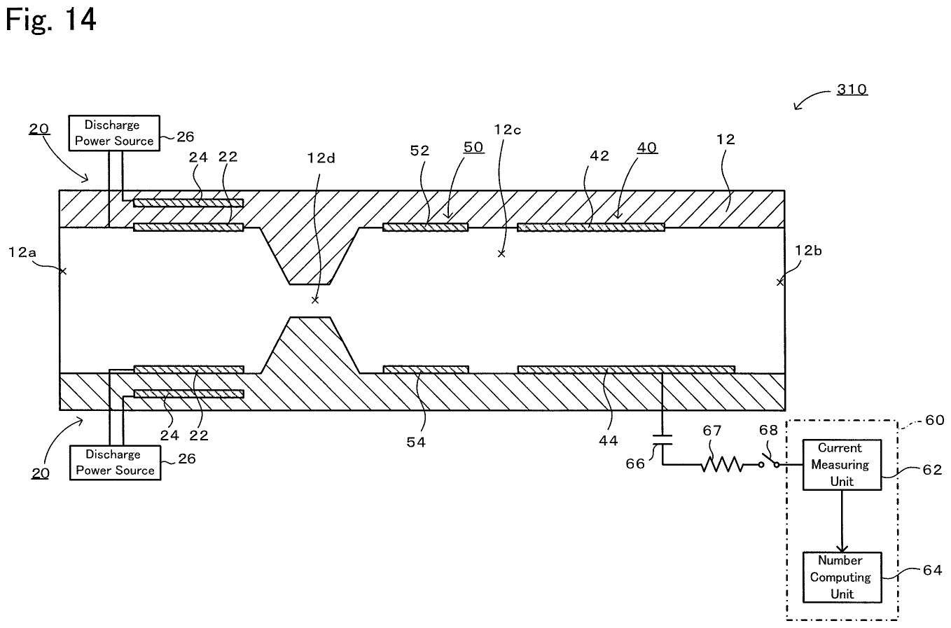

In the embodiment described above, a narrowed portion 12d may be provided between the excess charge removing unit 50 and the electric charge generating elements 20 within the hollow portion 12c of the vent pipe 12, as shown in a particle counter 310 in FIG. 14. In FIG. 14, the same components as those in the embodiment described above are denoted by the same numerals.

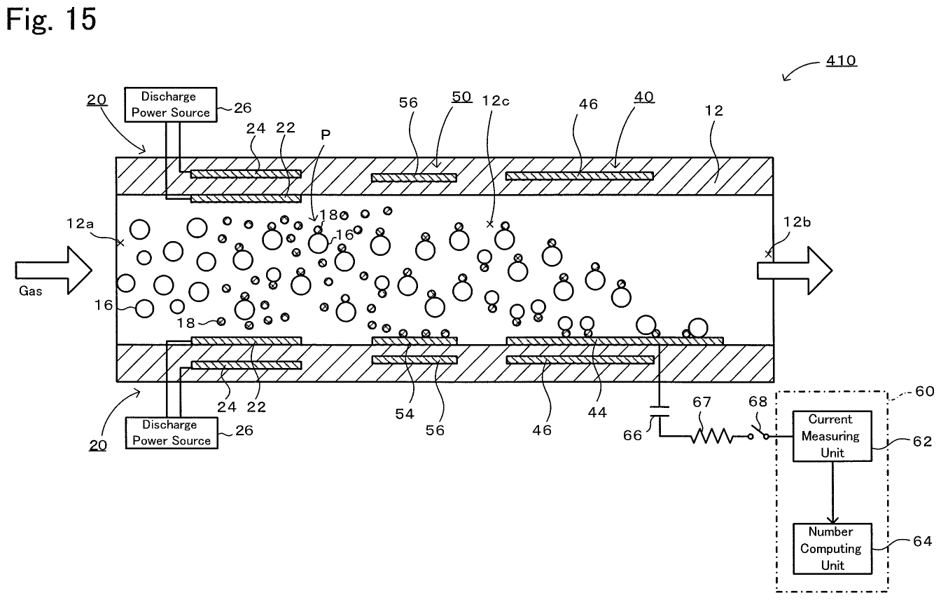

In the embodiment described above, the electric field generating electrodes 42 and 52 are disposed along the inner wall surface of the vent pipe 12. However, at least one of them may be embedded in the vent pipe 12. As shown in a particle counter 410 in FIG. 15, instead of the electric field generating electrode 42, a pair of electric field generating electrodes 46, 46 may be embedded in the vent pipe 12 so as to sandwich the collecting electrode 44. Instead of the electric field generating electrode 52, a pair of electric field generating electrodes 56, 56 may be embedded in the vent pipe 12 so as to sandwich the removing electrode 54. In FIG. 15, the same components as those in the embodiment described above are denoted by the same numerals. In this case, when a voltage is applied between the pair of electric field generating electrodes 46, 46 to generate an electric field on the collecting electrode 44, charged fine particles P are collected on the collecting electrode 44. When a voltage is applied between the pair of electric field generating electrodes 56, 56 to generate an electric field on the removing electrode 54, electric charges 18 are collected by the removing electrode 54 and removed.

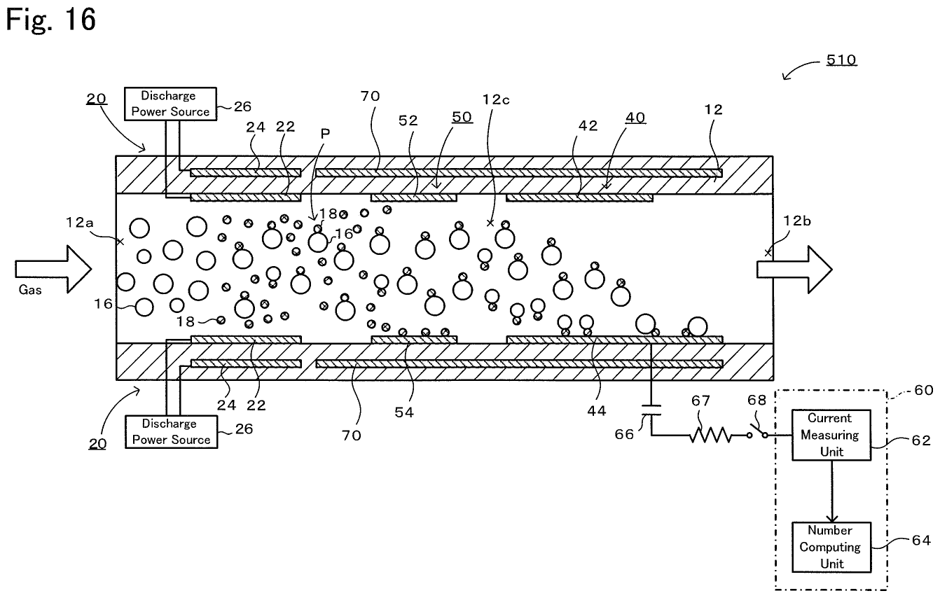

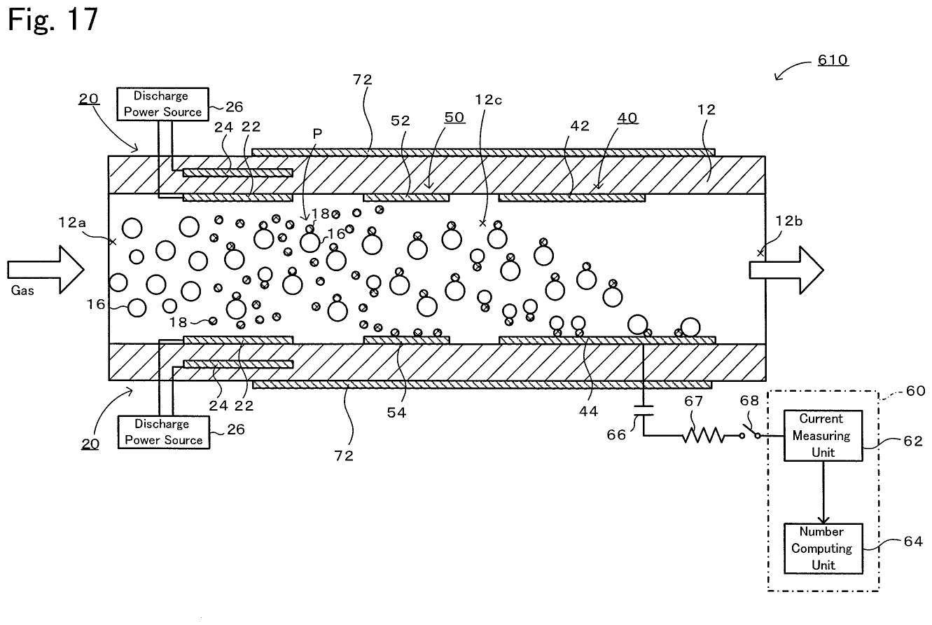

In the embodiment described above, a heater for refreshing the electrodes may be provided. For example, as shown in a particle counter 510 in FIG. 16, heaters 70 for heating and burning fine particles 16 and charged fine particles P adhering to the discharge electrodes 22, the ground electrodes 24, the collecting electrode 44, and the removing electrode 54 may be embedded in the ceramic-made vent pipe 12. Alternatively, as shown in a particle counter 610 in FIG. 17, a heater 72 similar to the above heaters may be wound around the outside of the ceramic-made vent pipe 12. In FIGS. 16 and 17, the same components as those in the embodiment described above are denoted by the same numerals. In the above structures, by energizing the heaters 70 and 72, the electrodes can be refreshed.

In the embodiment described above, the plurality of small protrusions 22a are disposed around each discharge electrode 22. However, the small protrusions 22a may be omitted.

The present application claims priority from Japanese Patent Application No. 2017-12023, filed on Jan. 26, 2017, the entire contents of which are incorporated herein by reference.

What is claimed is:

1. A particle counter comprising:
a ceramic-made vent pipe;
an electric charge generating element that includes a pair of electrodes for generating electric charges by gaseous discharge and adds the electric charges to fine particles in gas introduced into the vent pipe to thereby form charged fine particles;
a collecting electrode that is disposed downstream of the electric charge generating element in a flow of the gas within the vent pipe and collects the charged fine particles;
a collection electric field generating electrode that generates an electric field on the collecting electrode;
a removing electrode that is disposed between the electric charge generating element and the collecting electrode within the vent pipe and removes excess electric charges not added to the fine particles;
a removal electric field generating electrode that generates an electric field on the removing electrode; and
a number detecting unit that detects the number of charged fine particles on the basis of a physical quantity that varies according to the number of charged fine particles collected on the collecting electrode,
wherein one of the pair of electrodes included in the electric charge generating element, the collecting electrode, and the removing electrode are disposed along an inner wall surface of the vent pipe, and
wherein the other one of the pair of electrodes included in the electric charge generating element, the collection electric field generating electrode, and the removal electric field generating electrode are disposed along the inner wall surface of the vent pipe or embedded in the vent pipe.

2. The particle counter according to claim 1,
wherein the electrodes disposed along the inner wall surface of the vent pipe are joined to the inner wall surface of the vent pipe using an inorganic material.

3. The particle counter according to claim 1,
wherein the electrodes disposed along the inner wall surface of the vent pipe are joined to the inner wall surface of the vent pipe by sintering.

4. The particle counter according to claim 1, further comprising a plurality of the collecting electrodes that are disposed at intervals from an upstream side toward a downstream side in the flow of the gas.

5. The particle counter according to claim 1,
wherein the number detecting unit detects the number of charged fine particles on the basis of the capacitance of a pseudo capacitor composed of the collection electric field generating electrode, the collecting electrode, and an internal space of the vent pipe.

6. The particle counter according to claim 1, further comprising
a piezoelectric vibrator including a front electrode, a rear electrode, and a piezoelectric element sandwiched therebetween, the front electrode of the piezoelectric vibrator serving as the collecting electrode,
wherein the number detecting unit detects the number of charged fine particles on the basis of a resonance frequency that varies according to the number of charged fine particles collected on the front electrode.

7. The particle counter according to claim 1,
wherein the vent pipe is a cylindrical vent pipe prepared by joining two half members made of ceramic and each having a semicircular cross section.
